(19) United States
(12) Patent Application Publication
(10) Pub. No.: US 2011/0279033 A1
(43) Pub. Date: Nov. 17, 2011

(54) ELECTRONIC LAMP CONVERTER

(76) Inventors: Ching-Nan YANG, Yonghe City (TW); Tsung-Chih Kao, Yonghe City (TW); Chun-Hsin Yang, Yonghe City (TW)

(21) Appl. No.: 12/780,558

(22) Filed: May 14, 2010

(51) Int. Cl. H05B 37/03; H05B 37/02; H05B 41/36

(52) U.S. Cl. 315/86; 315/291; 315/149

(57) ABSTRACT

An electronic lamp converter allows a lamp socket of a different specification to be converted into a lamp socket which can be connected to an LED lamp. Through an electronic converter, electronic parameters are converted, wherein the electronic converter is electrically connected with at least a special function unit which enables the LED lamp to have an effect of changing a light source. Therefore, through the special function unit, the LED lamp is provided with functions of light dimming, light blending, color modulation, light induction, supplying uninterruptable power and motion detection.

### BACKGROUND OF THE INVENTION

a) Field of the Invention

The present invention relates to a lamp converter and more particularly to an electronic lamp converter which is applicable to various types of LED (Light Emitting Diode) lamps such that the LED lamps can be provided with a commonality, equipped with an advantage of energy saving and in a mean time provided with an effect of changing a light source.

b) Description of the Prior Art

Nowadays energy crisis and environmental pollution are major challenges to be confronted with when building a harmonic society and developing continuously. Therefore, development of new energy sources and renewable energy sources, energy saving and environmental protection have a significant meaning to future development in the world. An ordinary LED lamp is provided with high brightness, a longer lifetime of usage, a smaller size and a high reliability; in addition, it is also environmental friendly. Thus, the LED lamp is mostly used in commercial purposes and civilian illumination, playing a major role in energy saving and environmental protection in application of semi-conductor illumination. In general, many clients or factories have started to replace halogen lamp bulbs with the LED lamps, such that a total electricity consumption can be reduced and a sustainability of illumination can be increased. The LED lamps are generally very expensive on ordinary markets, wherein an element which is used shorter in time is actually an element on a circuit board in a lamp socket, such as an electrolytic capacitor or a low-voltage semi-conductor element. If the lamp socket, which is connected with the LED lamp, is broken, then the entire lamp socket, along with the LED lamp and a heat dissipation module, should be disposed together. This means that the good LED lamp needs to be disposed. Accordingly, it wastes a lot of resources and is not environmental friendly. Furthermore, as functions and color systems of the ordinary LED lamps are fixed and cannot be changed, if the function or coloration of a lamp source needs to be replaced, then the entire set of LED lamp should be replaced. This is not only inferior in practicability but also non-economical. In addition, the entire set of the LED lamp that is disposed, burnt down or no longer useable will further severely contaminate the entire environment.

On the other hand, when being applied in all kinds of places, most of the ordinary LED lamps are provided with dull coloration. Therefore, to improve an on-site mood, many kinds of LED lamps of various colors should be added and when being used in a different situation, different LED lamps should be fitted at all time. Besides, one cannot use a single LED lamp to perform functions of light dimming, color modulation and color temperature modulation independently. Accordingly, the practicability is not great and using many types of LED lamps will relatively spend more costs.

### SUMMARY OF THE INVENTION

The primary object of the present invention is to provide an electronic lamp converter, wherein an LED lamp is electrically connected with a lamp socket which is provided with at least a first connector, assembling with the LED lamp, and a second connector, different from a configuration of the first connector. The lamp socket is accommodated with an electronic converter which can perform conversion of electronic parameters flowing from the second connector to the first connector and add all kinds of special functions that were not available. The electronic converter includes primarily at least an AC (Alternating Current)-to-DC (Direct Current) unit such that when the second connector of the lamp socket is connected with an ordinary lamp socket, the electronic converter can convert the electronic parameters into parameters which can be used by the LED lamp and perform control of the special functions. In addition, the first connector can be connected with LED lamps of various configurations. The aforementioned electronic converter can convert the electronic parameters (voltage, current, etc.) into the electronic parameters that can be used by the LED lamps and for the aforementioned special functions, the electronic converter is primarily connected with a special function unit which can change a light source of the LED lamp, such as light dimming, color modulation and color temperature modulation (described in details below). By the aforementioned technologies, the issues existing in the prior art that if the lamp socket, which is connected with the LED lamp, is broken, then the entire lamp socket, along with the LED lamp and a heat dissipation module, should be disposed together, meaning that the good LED lamp needs to be disposed and thus, it wastes a lot of resources and is not environmental friendly; furthermore, as functions and color systems of the ordinary LED lamps are fixed and cannot be changed, if the function or coloration of a lamp source needs to be replaced, then the entire set of LED lamp should be replaced, which is not only inferior in practicability but also non-economical; whereas, the entire set of the LED lamp that is disposed, burnt down or no longer useable will further severely contaminate the entire environment can be solved, achieving an effect that by operation of the electronic converter in the lamp socket, for all kinds of various connectors, existing non-LED lamp connectors can be replaced by the LED lamps and the special functions can be added in. The present invention is also provided with advantages of energy saving, environmental friendliness and longer lifetime of usage. Furthermore, the lamp socket can be replaced independently without a need for replacing an entire lamp body, thereby achieving an object of longevity of the lamp body.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of a preferred embodiment of the present invention.

FIG. 2 shows a cutaway view of the preferred embodiment of the present invention.

FIG. 3 shows a block diagram of a first preferred embodiment of the present invention.

FIG. 4 shows a block diagram of a second preferred embodiment of the present invention.

FIG. 5 shows a block diagram of a third preferred embodiment of the present invention.

FIG. 6 shows a block diagram of a fourth preferred embodiment of the present invention.

FIG. 7 shows a block diagram of a fifth preferred embodiment of the present invention.

FIG. 8 shows a block diagram of a sixth preferred embodiment of the present invention.

FIG. 9 shows a block diagram of a seventh preferred embodiment of the present invention.

FIG. 10 shows a block diagram of an eighth preferred embodiment of the present invention.

FIG. 11 shows a block diagram of a ninth preferred embodiment of the present invention.

FIG. 12 shows a block diagram of a tenth preferred embodiment of the present invention.

### DETAILED DESCRIPTION OF THE PREFERRED EMBODIMENTS

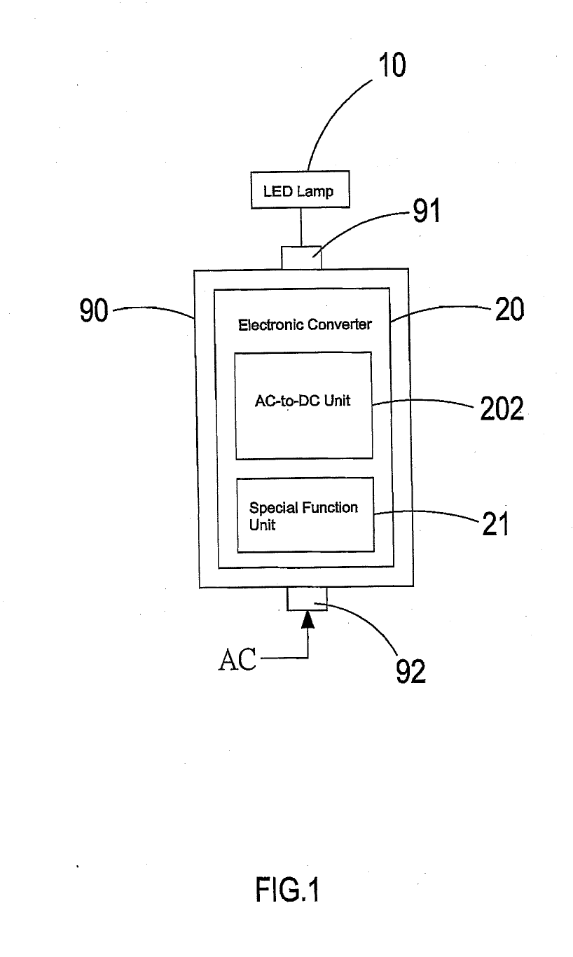

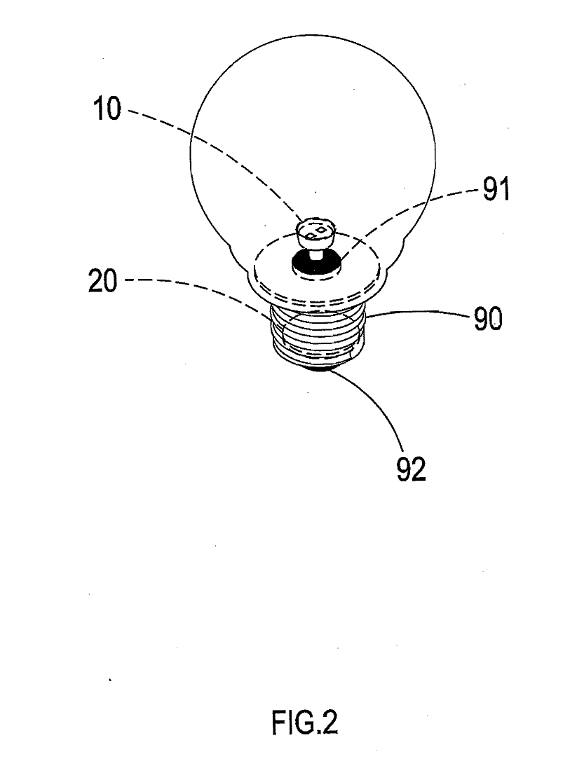

Referring to FIG. 1 and FIG. 2, it shows a block diagram and a cutaway view, of a preferred embodiment of the present invention. As shown in the drawings, the present invention comprises an LED lamp 10 which provides efficient illumination. The LED lamp 10 is electrically connected with a lamp socket 90 which is provided with at least a first connector 91, assembling with the LED lamp 10, and a second connector 92, different from a configuration of the first connector 91. The lamp socket 90 is accommodated with an electronic converter 20 which includes at least an AC-to-DC unit 202. The AC-to-DC unit 202 converts an alternating current (AC) to a direct current (DC) and the electronic converter 20 is electrically connected to a special function unit 21 by which the LED lamp 10 can be provided with an effect of changing a light source. When a user assembles the second connector 92 with a lamp socket of an ordinary specification, the alternating current is modulated through the AC-to-DC unit 202 and is outputted as the direct current which can be loaded by the LED lamp 10; that is, through the electronic converter 20, electronic parameters are converted and the said electronic parameters include voltage, current, etc. In addition, through the first connector 91, the LED lamp 10 of a different specification can be assembled and through the special function unit 21, the effect of changing from the original light source is achieved. The second connector 92 can be a connector of a standard specification, such as E27, E26, E14, E11, PAR38, PAR30, PAR20, PAR16, GU20, GU10, G24, G23 and B22; whereas, the first connector 91 is the connector that can be assembled with the LED lamp 10.

Moreover, the first connector 91 can be a connector of a standard specification, such as MR16, MR11, AR111, PAR38, PAR36, PAR30, GU10, JCG4, USB (Universal Serial Bus) and a DC power jack.

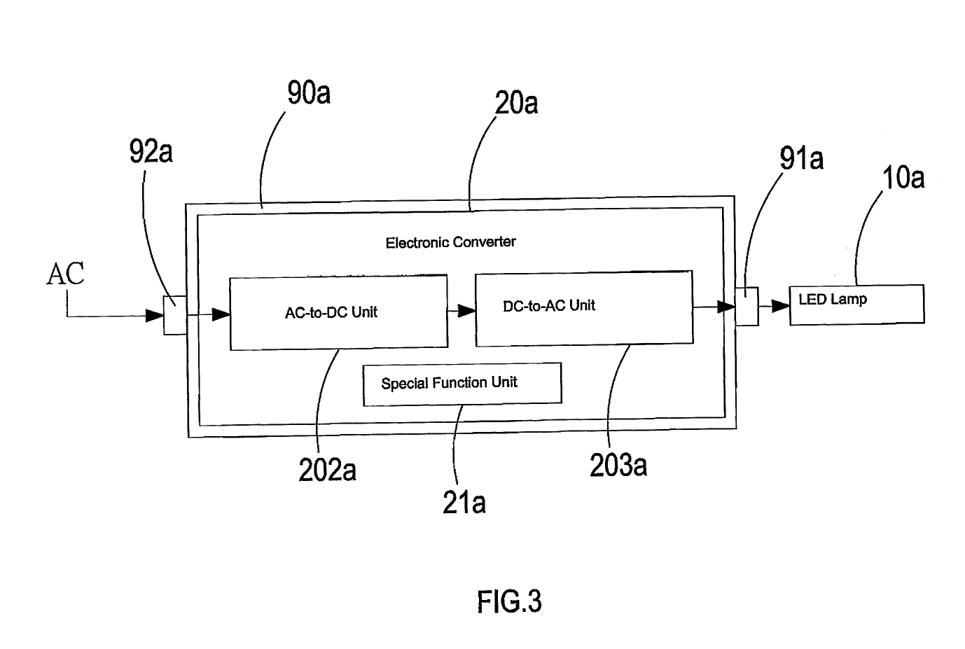

Referring to FIG. 3, it shows a block diagram of a first preferred embodiment of the present invention. As shown in the drawing, a lamp socket 90a is provided with at least a first connector 91 a, assembling with an LED lamp 10a, and a second connector 92a, different from a configuration of the first connector 91a. The lamp socket 90a is accommodated with an electronic converter 20a and a special function unit 21a which is electrically connected with the electronic converter 20a. The electronic converter 20a includes an AC-to-DC unit 202a and a DC-to-AC unit 203a. When the electronic converter 20a receives an alternating current from commercial power, the alternating current is modulated to a direct current through conversion of the AC-to-DC unit 202a, and then is modulated to an alternating current through second conversion of the DC-to-AC unit 203a. Accordingly, through the lamp socket 90a, the LED lamp 10a of a different specification can operate on an ordinary lamp socket, which is provided with advantages of energy saving, environmental friendliness and a longer lifetime of usage. In addition, there is no need to replace an entire lamp body, thereby achieving an object of extending a lifetime of the lamp body.

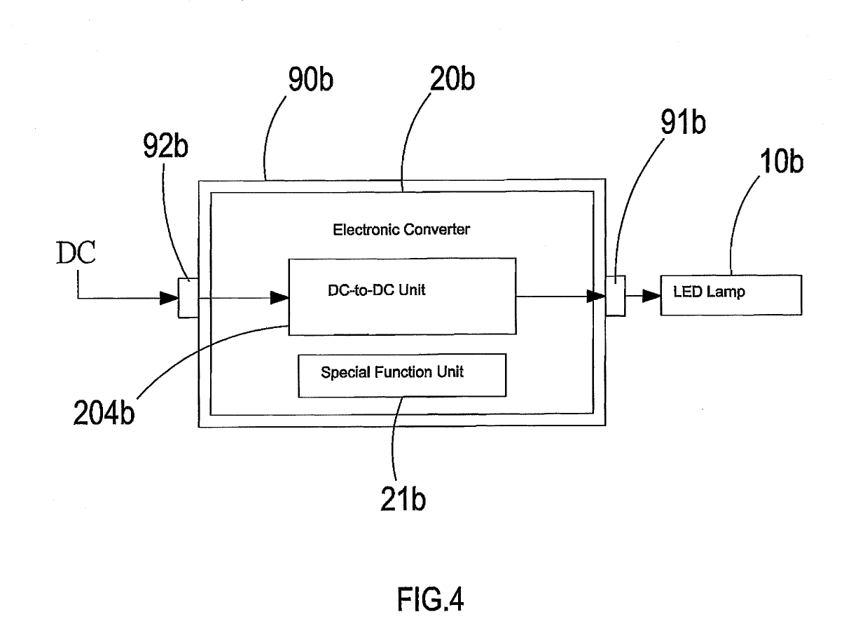

Referring to FIG. 4, it shows a block diagram of a second preferred embodiment of the present invention. As shown in the drawing, a lamp socket 90b is provided with at least a first connector 91b, assembling with an LED lamp 10b, and a second connector 92b, different from a configuration of the first connector 91b. The lamp socket 90b is accommodated with an electronic converter 20b and a special function unit 21b which is electrically connected with the electronic converter 20b. The electronic converter 20b includes a DC-to-DC unit 204b, such that when the electronic converter 20b receives a direct current, modulation is conducted through the DC-to-DC unit 204b to convert the direct current into a direct current that can be loaded by the LED lamp 10b. Accordingly, it also achieves effectively the conversion through the first connector 91b and the second connector 92b, which are two different configurations, of the lamp socket 90b, such that the LED lamp 10b can be energized to operate on an ordinary lamp socket, which is different from the configuration of the first connector 91b.

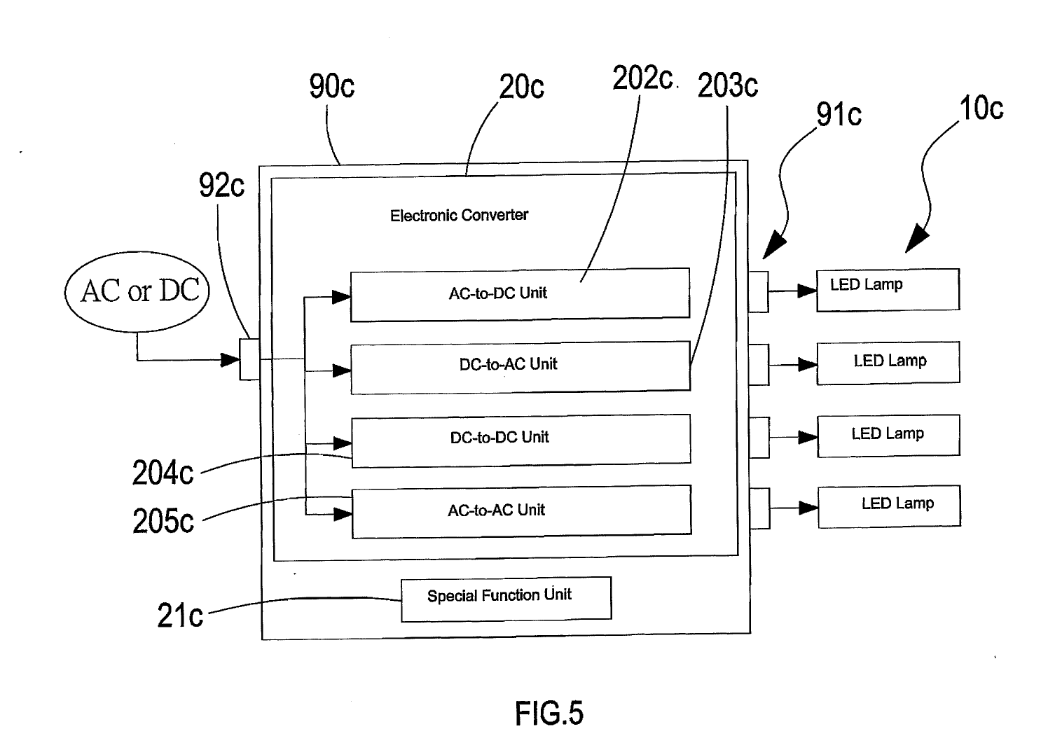

Referring to FIG. 5, it shows a block diagram of a third preferred embodiment of the present invention. As shown in the drawing, a lamp socket 90c is provided with at least a first connector 91c, assembling with an LED lamp 10c, and a second connector 92c, different from a configuration of the first connector 91c. The lamp socket 90c is accommodated with an electronic converter 20c and a special function unit 21c which is electrically connected with the electronic converter 20c. Through the first connector 91c, plural LED lamps 10c can be assembled simultaneously on the lamp socket 90c to operate at a same time. The electronic converter 20c includes primarily an AC-to-DC unit 202c, a DC-to-AC unit 203c, a DC-to-DC unit 204c and an AC-to-AC unit 205c. Accordingly, it also achieves effectively conversion through the first connector 91c and the second connector 92c, which are two different configurations, of the lamp socket 90c, such that the LED lamp 10c can be energized to operate on an ordinary lamp socket which is different from the configuration of the first connector 91c.

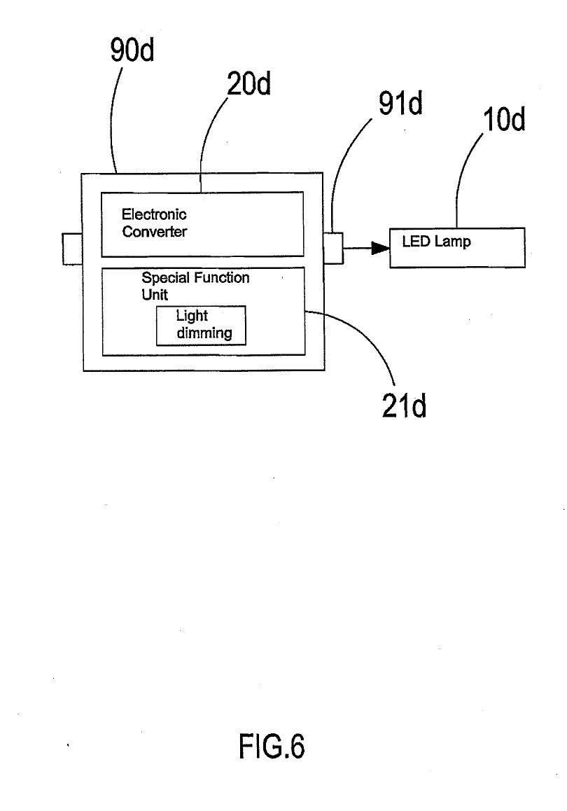

Referring to FIG. 6, it shows a block diagram of a fourth preferred embodiment of the present invention. As shown in the drawing, a first connector 91d of a lamp socket 90d is assembled with an LED lamp 10d, whereas the lamp socket 90d is accommodated with an electronic converter 20d and a special function unit 21d which is electrically connected with the electronic converter 20d. The special function unit 21d is further provided with a light dimming function and by the special function unit 21d, brightness of a light source can be converted. When the user is to convert the brightness of the light source, he or she continues to change a switch to conduct adjustment of the brightness at every stage, thereby changing the light source in multi-function and variety.

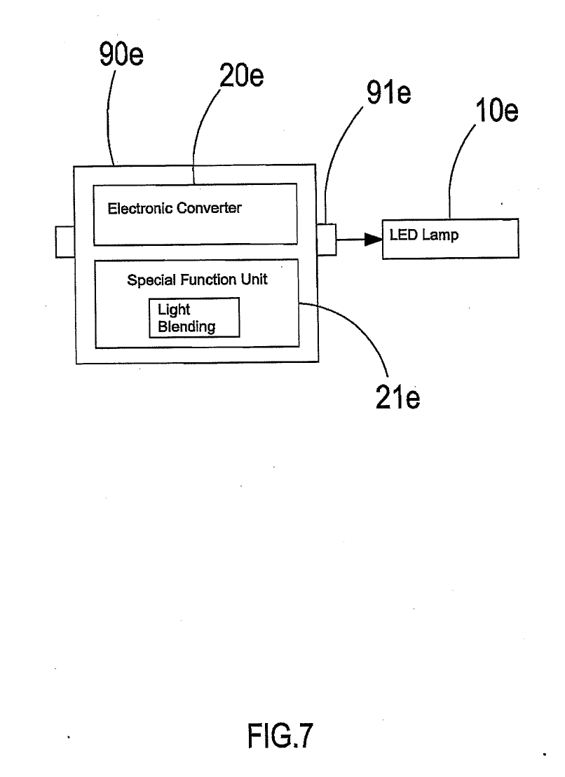

Referring to FIG. 7, it shows a block diagram of a fifth preferred embodiment of the present invention. As shown in the drawing, a first connector 91e of a lamp socket 90e is assembled with an LED lamp 10e, whereas the lamp socket 90e is accommodated with an electronic converter 20e and a special function unit 21e which is electrically connected with the electronic converter 20e. The special function unit 21e is further provided with a light blending function and by the special function unit 21e, conversion of a color temperature of the light source can be performed that a light color of a various configuration can be manifested on the LED lamp 10e and coloration of a different color can be changed to for a different situation, which is extremely convenient and versatile.

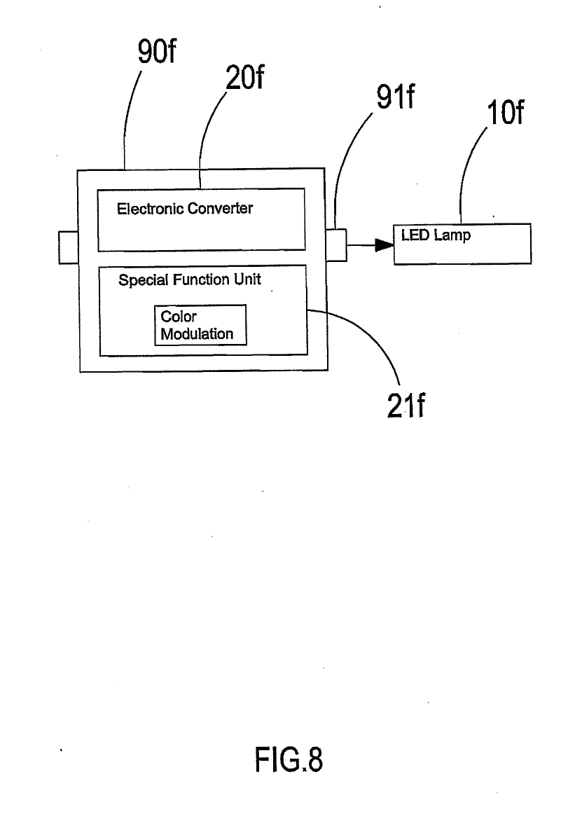

Referring to FIG. 8, it shows a block diagram of a sixth preferred embodiment of the present invention. As shown in the drawing, a first connector 91f of a lamp socket 90f is assembled with an LED lamp 10f, whereas the lamp socket 90f is accommodated with an electronic converter 20f and a special function unit 21f which is electrically connected with the electronic converter 20f. By the special function unit 21f, a color of the light source can be changed, allowing the LED lamp 10f to manifest the light source of a specific color.

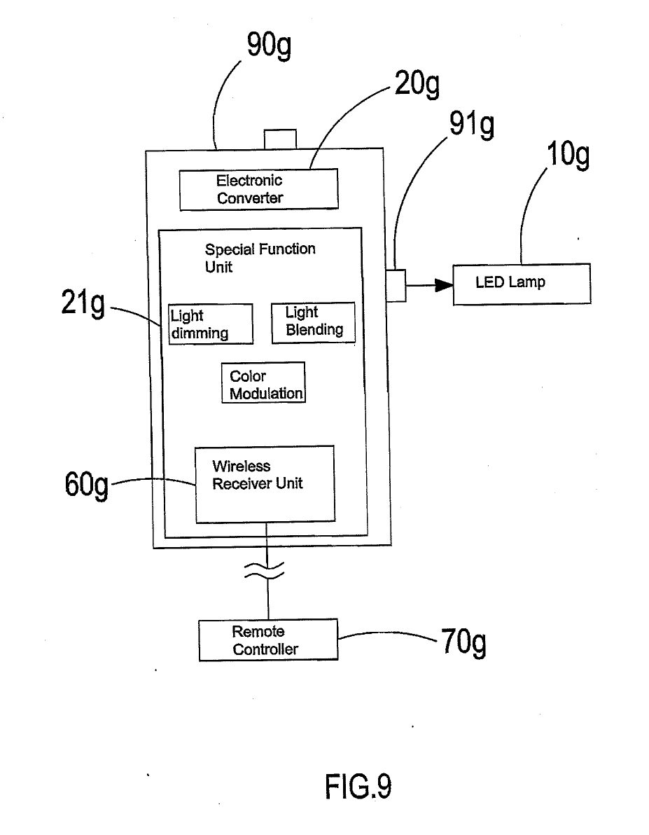

Referring to FIG. 9, it shows a block diagram of a seventh preferred embodiment of the present invention. As shown in the drawing, a first connector 91g of a lamp socket 90g is assembled with an LED lamp 10g, whereas the lamp socket 90g is accommodated with an electronic converter 20g and a special function unit 21g which is electrically connected with the electronic converter 20g. The special function unit 21g is further provided with a light dimming function to adjust brightness of the light source, a light blending function to adjust a color temperature of the lamp and a color modulation function to adjust to a specific color. The special function unit 21g is electrically connected with a wireless receiver unit 60g which is similarly provided in the lamp socket 90g. The wireless receiver unit 60g receives signals from a remote controller 70g to remotely control brightness, a color temperature and a specific color of the LED lamp 10g, through the wireless signals. After the remote controller 70g has emitted signals and the signals have been received by the wireless receiver unit 60g, signals are transmitted to control the special function unit 21g which conducts the light dimming or controls the light blending to change the color temperature or controls the color modulation to manifest a specific color. On the other hand, the LED lamp 10g can be also turned on or off through the remote controller 70g, achieving a great convenience.

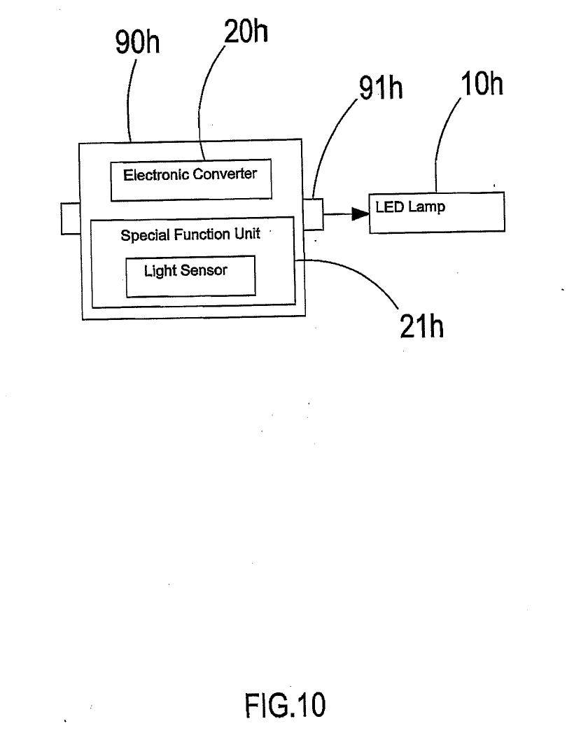

Referring to FIG. 10, it shows a block diagram of an eighth preferred embodiment of the present invention. As shown in the drawing, a first connector 91h of a lamp socket 90h is assembled with an LED lamp 10h, whereas the lamp socket 90h is accommodated with an electronic converter 20h and a special function unit 21h which is electrically connected with the electronic converter 20h. The special function unit 21h is further provided with a light sensor by which brightness of the light source can be inducted to transmit a message to the LED lamp to operate. When sky is dimmer and the light sensor induces that the brightness is not enough, the message is transmitted to the electronic converter 20h to simultaneously control the LED lamp 10h, enabling the LED lamp 10h to automatically illuminate when the sky is dim. On the contrary, if the sky is brighter, then the LED lamp 10h is turned off.

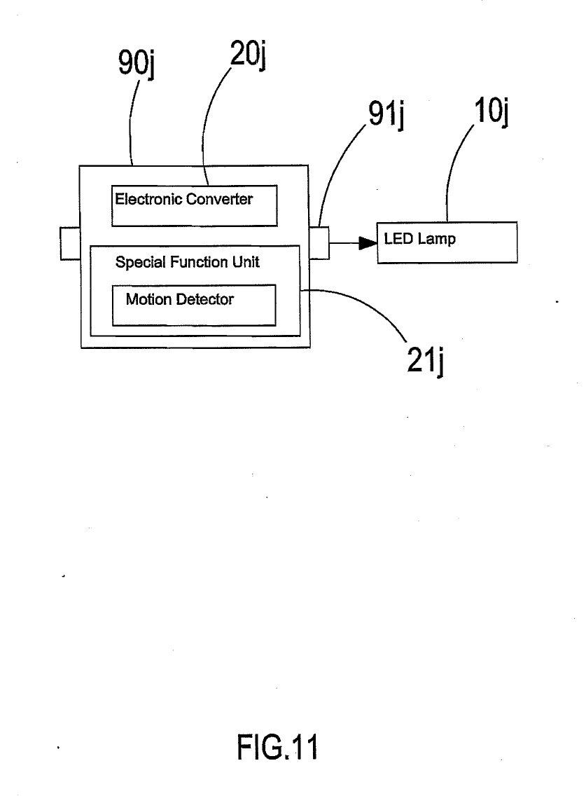

Referring to FIG. 11, it shows a block diagram of a ninth preferred embodiment of the present invention. As shown in the drawing, a first connector 91j of a lamp socket 90j is assembled with an LED lamp 10j, whereas the lamp socket 90j is accommodated with an electronic converter 20j and a special function unit 21j which is electrically connected with the electronic converter 20j. The special function unit 21j is further provided with a motion detector. When the motion detector detects movement, a message is transmitted to the electronic converter 20j to control simultaneously the LED lamp 10j. On the contrary, if there is no message of movement, then the LED lamp 10j will not operate.

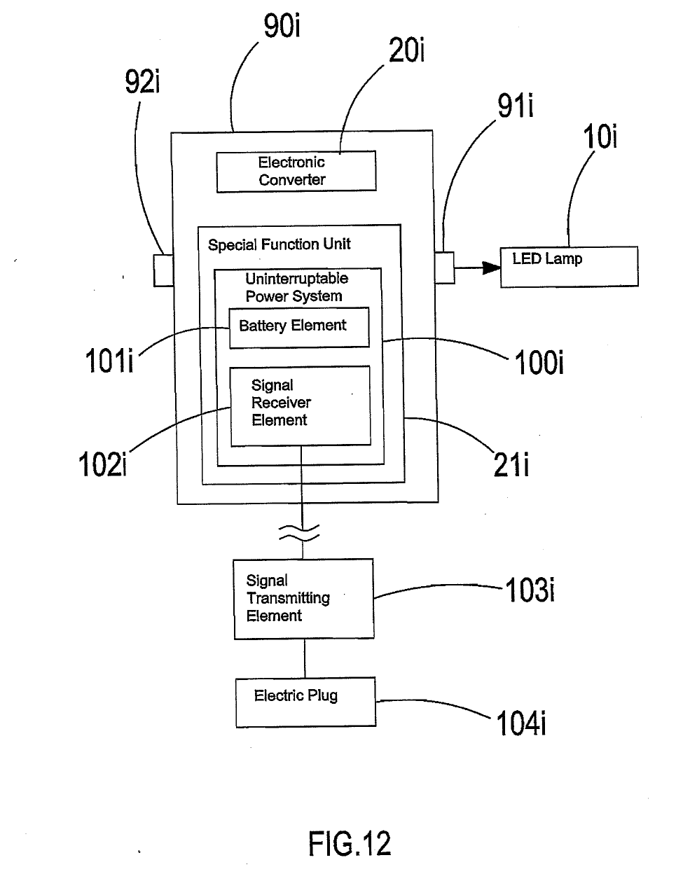

Referring to FIG. 12, it shows a block diagram of a tenth preferred embodiment of the present invention. As shown in the drawing, a first connector 91i of a lamp socket 90i is assembled with an LED lamp 10i, whereas the lamp socket 90i is accommodated with an electronic converter 20i and a special function unit 21i which is electrically connected with the electronic converter 20i. The special function unit 21i is further provided with an uninterruptable power system, allowing the LED lamp 10i to continue illumination when power failures. The uninterruptable power system includes at least a battery element 101i and a signal receiver element 102i which is electrically connected with the battery element 101i. The signal receiver element 102i is used to receive a message of a signal transmitting element 103i which is provided at an electric plug 104i and is at an on-state. When no electricity is conducted at the electric plug 104i, the signal transmitting element 103i will stop transmitting the message; whereas, when the signal receiver element 102i cannot receive the message transmitted from the signal transmitting element 103i, the signal receiver element 102i will activate the battery element 101i, allowing the battery element 101i to continue energizing the LED lamp 10i. Accordingly, through the uninterruptable power system, necessary electricity will be provided to the LED lamp 10i to continue illuminating, when there is no electricity to the second connector 92i.

Accordingly, technical keys of the electronic lamp converter, of the present invention, to improve the prior art are that:

1. It saves a lot of energy.

2. It is provided with the extremely high commonality.

3. Through the operation of the electronic converter 20 in the lamp socket 90, for all kinds of connectors, the LED lamp 10 can be used to replace the existing non-LED lamp 10, which is also provided with the advantages of energy saving, environmental friendliness and a longer lifetime of usage. Besides, the lamp socket 90 can be replaced independently without a need for replacing the entire lamp body, thereby achieving the object of extending the lifetime of the lamp body.

4. Through the light dimming function of the special function unit 21, the brightness of the light source can be changed by the user.

5. Through the light blending function of the special function unit 21, the color temperature of the light source can be changed by the user.

6. Through the color modulation function of the special function unit 21, the color of the light source can be changed by the user.

7. By the remote controller 70g, the LED lamp 10g can be remotely controlled to turn on or off or the brightness, the color temperature or the color can be changed, which is extremely convenient.

8. Through the electronic converter 20, an ordinary illuminating lamp can be converted for use in an automatic illuminating lamp, a burglar-proof automatic illuminating lamp, a projection-type lamp or an emergency illuminating lamp.

9. By the light sensor of the special function unit 21h, the brightness of the light source can be inducted to transmit the message to the electronic converter 20h to operate.

10. By the motion detector of the special function unit 21, a movement of a person or an animal can be detected to illuminate.

11. Through the uninterruptable power system of the special function unit 21i, the necessary electricity can be provided to the LED lamp 10i to continue illuminating, when there is no electricity to the second connector 92i.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An electronic lamp converter, being electrically connected with an LED (Light Emitting Diode) lamp and constituted by a lamp socket which is provided with a first connector, assembling with the LED lamp, and a second connector, different from a configuration of the first connector, with the converter comprising:
an electronic converter which is accommodated in the lamp socket to perform conversion of electronic parameters flowing from the second connector to the first connector; and
a special function unit which is electrically connected with the electronic converter, allowing the LED lamp to have an effect of changing a light source.

2. The electronic lamp converter according to claim 1, wherein the electronic converter further includes an AC (Alternating Current) -to-DC (Direct Current) unit, an AC-to-AC unit, a DC-to-AC unit and a DC-to-DC unit.

3. The electronic lamp converter according to claim 1, wherein the special function unit is further provided with a light dimming function to convert brightness of a light source.

4. The electronic lamp converter according to claim 1, wherein the special function unit is further provided with a light blending function to convert a color temperature of a light source.

5. The electronic lamp converter according to claim 1, wherein the special function unit is further provided with a color modulation function to convert a color of a light source.

6. The electronic lamp converter according to claim 1, wherein the electronic converter is further electrically connected with a wireless receiver unit.

7. The electronic lamp converter according to claim 6, wherein the wireless receiver unit receives signals sent from a remote controller.

8. The electronic lamp converter according to claim 1, wherein the special function unit is further provided with a light sensor to induce brightness of a light source to transmit messages to the LED lamp for operation.

9. The electronic lamp converter according to claim 1, wherein the special function unit is further provided with an uninterruptable power system, enabling the LED lamp to continue illuminating when power failures, with the uninterruptable power system including a battery unit and a signal receiver element which is electrically connected with the battery unit.

10. The electronic lamp converter according to claim 9, wherein the signal receiver unit is used to receive a message of a signal transmitting element which is provided at an electric plug and is at an on-state.

11. The electronic lamp converter according to claim 1, wherein the special function is further provided with a motion detector.

12. The electronic lamp converter according to claim 1, wherein the second connector is a conventional lamp socket of a standard specification, including E27, E26, E14, E11, PAR38, PAR30, PAR20, PAR16, GU20, GU10, G24, G23 and B22.

13. The electronic lamp converter according to claim 1, wherein the first connector is a conventional lamp socket of a standard specification, including MR16, MR11, E14, AR111, PAR38, PAR36, PAR30, GU10, JCG4, USB (Universal Serial Bus) and a DC power jack.

14. The electronic lamp converter according to claim 1, wherein the electronic parameters include voltage and current.
